(19) United States
(12) Patent Application Publication
(10) Pub. No.: US 2013/0065469 A1
(43) Pub. Date: Mar. 14, 2013

(54) LARGE TOW CARBON FIBER COMPOSITE WITH IMPROVED FLEXURAL PROPERTY AND SURFACE PROPERTY

(71) Applicants: Hyun Min Kang, Seongnam (KR); Sang Mu Lee, Jeonju (KR); Chi Hoon Choi, Suwon (KR); Cheol Choi, Hwaseong (KR); Sang Sun Park, Anyang (KR)

(72) Inventors: Hyun Min Kang, Seongnam (KR); Sang Mu Lee, Jeonju (KR); Chi Hoon Choi, Suwon (KR); Cheol Choi, Hwaseong (KR); Sang Sun Park, Anyang (KR)

(73) Assignees: KIA MOTORS CORPORATION, Seoul (KR); HYUNDAI MOTOR COMPANY, Seoul (KR)

(21) Appl. No.: 13/300,910

(22) Filed: Nov. 21, 2011

(30) Foreign Application Priority Data
Sep. 9, 2011 (KR) 10-2011-0092201

(51) Int. Cl. B32B 5/02; B32B 5/26

(52) U.S. Cl. 442/203; 442/327; 442/335; 442/415

(57) ABSTRACT

Disclosed is a carbon fiber composite comprising 30 to 80 wt % of a carbon fiber textile wherein a carbon fiber tow size is 24K to 100K; 0.1 to 20 wt % of a carbon non-woven fabric whose weight per unit area is 10˜500 g/m²; and 10 to 70 wt % of a polymer resin whose viscosity at transference thereof is 0.01˜10 Pa·s. Advantageously, it is possible to obtain a molded product of the carbon fiber composite which has good surface properties and flexural properties by selectively applying the carbon non-woven fabric to a surface of the material thereof using the carbon fiber composite.

### CROSS-REFERENCE TO RELATED APPLICATION

This application claims under 35 U.S.C. §119(a) the benefit of Korean Patent Application No. 10-2011-0092201 filed Sep. 9, 2011, the entire contents of which are incorporated herein by reference.

### BACKGROUND

(a) Technical Field

The present invention relates to a carbon fiber composite wherein a large tow carbon fiber is applied thereto in order to improve productivity and to reduce the cost of a carbon fiber composite molding process via a resin transfer molding method, and which can improve problems associated with surface properties caused by the application thereof while at the same time providing a composite with good flexural properties.

(b) Background Art

A carbon fiber composite having excellent specific strength in comparison with a steel and light metal has conventionally only been applied to military equipment and aerospace equipment which require extremely strong light weight materials. Additionally, it has also been applied to the chassis and body parts of racing cars or expensive cars because of its prohibitively expensive cost. However, its application has resulted in a reduction of fuel consumption, corrosion resistance, impact stability and agility due to carbon fibers light weight. Additionally, due to its moldability, its use increases the degree of design freedom. However, full-scale application to an automobile industry for mass production is not yet realized due to the low productivity and the high cost of the carbon fiber composite.

Recently, interest in applying a carbon fiber composite to a hybrid car and electric car has increased due to enhanced environmental regulations and continuously high oil prices. Its use in these vehicles would reduce the overall weight of the vehicle and reduce the required battery capacity and motor size as well while at the same time increasing driving performance and driving range as. Its application may also reduce battery and motor prices, as well.

Accordingly, various attempts have been made to solve a productivity problem which is one of the biggest problems associated with its application in the mass production industry because it requires the developing of a molding technique to improve productivity of a composite molded product which would having high strength/rigidity and high quality. One molding method for carbon fiber composite to be used as a structural material is a laminating prepregs method. More specifically, a resin is pre-impregnated before molding thereof at high temperature/pressure.

However, this method is being gradually replaced with Resin Transfer Molding (RTM) method due to its low productivity and high cost, as well. In particular, carbon fiber textile having a certain shape is put into a mold, and a thermoset resin is transferred into a mold cavity followed by impregnation thereof in the textile coincident with hardening thereof to obtain a molded product. A mold for transferring the resin is typically a mold having high rigidity, but in case of a large molded product, a flexible material is used to a part of the mold.

Traditionally, VaRTM (Vacuum Assisted Resin Transfer Molding) process has also been used to reduce resin transfer time. VaRTM applies a vacuum to the opposite site of a resin inlet in this method. However, if a flexible material is applied to a part of a mold, the resin cannot be diffused to a textile because the resin flow is blocked due to the close contact of the mold with a molding material.

In order to solve these problems, a mesh form sheet as a resin diffusion media is typically used to make the resin diffusion easy. However, this resin diffusion media is typically removed from a composite molded product and disposed of. The resin diffusion media is needed to efficiently diffuse the resin, but that the production cost can increase and the environmental problems can be caused due to the media being removed after molding.

As one method to solve these problems, a method which forms a groove for resin diffusion on a surface of a core material such as polyurethane forming agents has been used (Japanese patent No. 2000-501659 and Japanese patent No. 2001-510748). Further, as a similar technique, a method of forming a groove for resin diffusion in a forming mold (Japanese patent application publication No. 2001-62932) has also been contemplated. These methods, however, do not address the surface quality degradation which can be incurred when the large tow carbon fiber is applied.

Mostly, a carbon fiber composite which has been applied to aerospace industry is small tow of 1˜12K [K refers to 1,000, and 12K refers to a bundle of carbon fibers that make up 12,000 fibers having 7˜10 μm diameter], but the use of large tow carbon fiber of 24K˜50K in industrial materials including vehicles is becoming increasingly desirable. When the large tow carbon fiber is used, the productivity can be improved because production volume per unit time increases, and the cost is also reduced because the large tow carbon fiber is cheaper than the small tow carbon fiber. Accordingly, a solution for the resin transfer molding process which provides good surface properties even when the large tow carbon fiber is needed. It is also desirable that the method also has increased productivity and the ability to reduce cost.

### SUMMARY OF THE DISCLOSURE

The present invention provides a composite which prevents or reduces significantly surface quality degradation generated when a composite using a large tow carbon fiber and also improves productivity and reduces costs while being prepared by a resin transfer molding method.

In one aspect, the present invention provides a carbon fiber composite which is composed of 30 to 80 wt % of a carbon fiber textile wherein a carbon fiber tow size is 24K to 100K, 0.1 to 20 wt % of a carbon non-woven fabric, and 10 to 70 wt % of a polymer resin.

The above and other features of the invention are discussed infra.

### BRIEF DESCRIPTION OF THE DRAWINGS

The above and other features of the present invention will now be described in detail with reference to certain exemplary embodiments thereof illustrated the accompanying drawings which are given hereinbelow by way of illustration only, and thus are not limitative of the present invention, and wherein:

FIG. 1 is a schematic diagram of a resin transfer molding process according to one exemplary embodiment of the present invention;

FIGS. 2A, B is an image representing a planar surface of a large tow carbon fiber composite before (A) or after (B) applying a composition according to one exemplary embodiment of the present invention; and

FIGS. 3A, B is an image representing a surface of a flexural part of a large tow carbon fiber composite before (A)or after (B) applying a composition according to one exemplary embodiment of the present invention.

Reference numerals set forth in the Drawings includes reference to the following elements as further discussed below:

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter reference will now be made in detail to various embodiments of the present invention, examples of which are illustrated in the accompanying drawings and described below. While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is a vehicle that has two or more sources of power, for example both gasoline-powered and electric-powered vehicles.

The present invention relates to a carbon fiber composite which is a thermoset carbon fiber composite using a large tow carbon fiber produced by a resin transfer molding method, and having good surface and flexural properties.

The carbon fiber composite according to one characteristic of the present invention comprises 30 to 80 wt % of a carbon fiber textile having a carbon fiber tow size of 24K to 100K, 0.1 to 20 wt % of a carbon non-woven fabric having weight per unit area of 10˜500 g/m², and 10 to 70 wt % of a resin having a viscosity at injecting of 0.01˜10 Pa˜s. This composite is characterized by good surface properties and flexural properties by selectively applying the carbon non-woven fabric to the material surface when the composite is prepared by a resin transfer molding method.

The carbon fiber can be any fiber including a fiber prepared from polyacrylonitrile (PAN) fiber, pitch fiber, rayon fiber or lignin fiber. The carbon fiber can be manufactured by mixing the fiber with other kinds of fiber, and when two or more fibers are mixed together, a fiber other than the carbon fiber such as a glass fiber or aramid fiber can be used together. This carbon fiber may be a PAN-based carbon fiber having good physical properties such as strength and elastic modulus and balance with cost, preferably. Generally, the carbon fiber is handled with one or more surface treatment methods or materials. The suitable surface treatment method is a method wherein the carbon fiber surface is oxidized with a proper method, and coated thereof with a material such as polyamide, urethane and epoxy. The oxidization of the carbon fiber surface by the proper method can be accomplished by introducing a functional group which can exhibit good adhesive force with the coating material thereafter. This helps to improve dispersibility of the fiber in the composition. The amount of coating material used in the surface treatment can be about 0.1 to about 10 wt % based on the total weight of the carbon fiber.

A crystal size which is measured by Wide-Angle X-ray Scattering (WAXS) of the carbon fiber used in the present invention may be in a range of 1 to 6 nm, preferably. If the size is less than 1 nm, a specific strength of the carbon fiber itself may decrease because the carbonization or graphitization of the carbon fiber is not sufficient. Therefore, there are some cases that mechanical strength of the obtained molded product goes down. However, if the size exceeds 6 nm, conductivity of the carbon fiber itself is excellent due to sufficient carbonization and graphitization of the carbon fiber, but the fiber is weak and easy to be damaged, and thus, it is not prefer to have a good physical property compensation effect because fiber length in the molded product is easily shorten. The size may be in a range of 1.3 to 4.5 nm, more preferably 1.6 to 3.5 nm, and most preferably and particularly 1.8 to 2.8 nm. An average single fiber diameter of the carbon fiber is in a range of 1 to 20 μm, preferably 4 to 15 μm, more preferably 5 to 11 μm, and most preferably 6 to 8 μm. If the diameter is less than 1 μm, the desired mechanical properties may not be obtained, and if it exceeds 20 μm, specific strength compensation effect may decrease.

The amount of the carbon fiber may be about 30 to about 80 wt % preferably, based on the total weight of the composition, about 40 to 60 wt % more preferably, and about 40 to about 50 wt % even more preferably. If the amount is less than 30 wt %, the desired mechanical strength may not be obtained, and if it exceeds 80 wt %, decreased formability may be incurred because the molding resin cannot fully impregnate a stiffener. Thus it would be difficult to produce a sufficiently light product.

The carbon fiber tow size can be 24K-100K preferably at the point of productivity and cost reduction, 30 to 70K more preferably, and 40 to 60K most preferably. If the size is less than 24K, the carbon fiber may not be competitive in the point of cost and productivity, and if it exceeds 100K, the properties may be deteriorated due to large bubbling caused by low impregnation property.

In the present invention, there are three kinds of the carbon fiber textiles such as a plain weave, twill weave and satin weave like a general textile, which are called a three foundation weave or an original weave which becomes fundamental in modifying or inducing the weaves. The original weave can be modified and applied by adjusting thereof to specifications of a final molded product.

A weight per unit area of the carbon non-woven fabric which can be selectively applied to a surface of the composite may be 10 to 500 g/m² preferably, 100 to 300 g/m² more preferably, and 150 to 200 g/m² most preferably. If the weight per unit area is less than 10 g/m², the fabric strength may become too low because the thickness thereof may become too thin and the porosity thereof may become too large, so that handling may not be easy during the application, and if it exceeds 500 g/m², the physical property of the composite itself may critically decrease because the product is over-thickened.

The carbon non-woven fabric can be used preferably in an amount of about 0.1 to about 20 wt %, based on the total weight of the composite, more preferably 1 to 15 wt %, and most preferably 5 to 10 wt %. If the amount is less than 0.1 wt %, it is difficult to implement the enhancement of the surface and flexural properties. Meanwhile, if it exceeds 20 wt %, the desired mechanical property cannot be obtained.

In the present invention, the viscosity of the thermoset resin at transference thereof may be preferably 0.01 to 10 Pa·s, more preferably about 0.01 to 5 Pa·s, and most preferably about 0.01 to 1 Pa·s. If the resin viscosity at transfer is less than 0.01 Pa s, the physical property may decrease and bubbles may be generated by evaporation of the low molecular component during hardening. In contrast, if it exceeds 10 Pa s, bubbles are generated because the resin is not fully impregnated by reduction of flexibility during molding, so that physical properties may go down.

In the present invention, an amount of the resin may be preferably 10 to 70 wt %, more preferably 20 to 60 wt %, and most preferably 25 to 50 wt %. If the resin amount is less than 20 wt %, the properties may decrease due to low impregnation properties. In contrast, if it exceeds 70 wt %, the desired mechanical properties as a structure material cannot be obtained.

There are chemical resistance, mechanical, thermal and electrical properties, and environmental resistance as a standard to select the applicable resin. As one example, isophthalic polyester can be used when the high and moderate chemical resistance is required; a vinylester-based resin can be used when the high corrosion resistance is further required; and a low viscosity epoxy resin can be used when the high mechanical and thermal properties are required. The composition of the present invention may further comprise a flame retardant, antioxidant, heat stabilizer, lubricant, dye, pigment and inorganic filler in addition to the constituents.

The composition is used in a resin transfer molding process so as to provide a molded product. This process can prepare a complicated three-dimensional structure having anisotropy of fiber reinforcement composite, and has significant product reliability and reproducibility characteristics, so that it is suitable for composite part molding. Further, in mass production, complicated shapes can be prepared at low cost, and high-precision products can be realized. The resin transfer molding process is conducted by putting a reinforcing fiber pre-form to a mold of a desired shape and by transferring a resin into the mold through an inlet followed by heating for molding. The resin transfer molding (RTM) method has a low initial cost for mold preparation, equipment and devices such as the transfer machine because it is operated at lower pressures (e.g., 20˜50 psi) than other resin transfer molding. Further, control of the amount and direction of an internal stiffener and installation such as insertion for connecting thereof with other parts is simplified.

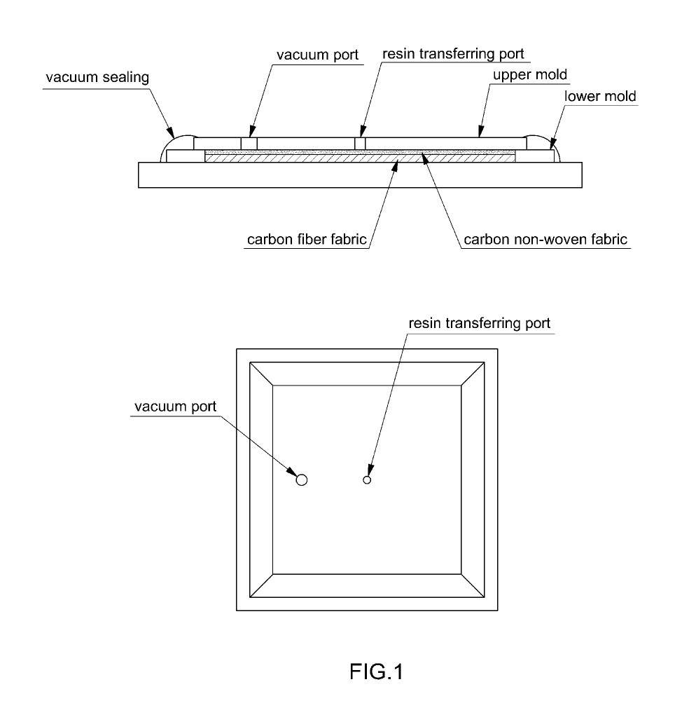

FIG. 1 shows a schematic diagram of a resin transfer molding process used in the present invention, as can be seen from the illustration there is a port where pressure is applied to the opposite side of the resin input site for low pressure molding in order to improve a transfer rate and quality. The carbon non-woven fabric, as described above, is located on the surface to enhance the surface properties by smoothing the resin fluidity as shown in FIG. 1. According to the purpose of the product, the fabric can be located followed by modifying the shape to a shape which covers the upper side, the lower side or the entire carbon fiber textile. Thus, when the carbon non-woven fabric is selectively applied to the surface or a part, the part exhibits good surface properties and excellent flexural strength/rigidity .

The molded product produced as described above can be applied to electric car components and structure/semi-structure material having significantly reduced weight. A preferable item may include a spare tire floor, tail gate and/or seat frame which are required to have both good surface quality and flexural properties.

### EXAMPLE

Hereinafter, the following examples are provided to further illustrate the invention, but they should not be considered as the limit of the invention. The following examples illustrate the invention and are not intended to limit the same.

Methods applied to Example of the present invention are described as follows.

(1) Flexural Property Measurement

The flexural strength and rigidity were measured at 2 mm/min of cross-head rate by three points bending flexural test using the prepared test piece according to ASTM D790, and the results were listed in Table 1. The test piece, wherein the carbon non-woven fabric was applied to one side thereof, was placed as the carbon non-woven fabric side was faced upward, and the flexural property was measured.

(2) Tensile Property Measurement

The tensile strength and rigidity were tested at 5 mm/min of cross-head rate by using the prepared test piece according to ASTM D30309, and the results were listed in Table 1.

(3) Specific Gravity Measurement

The specific gravity was measured by using the prepared test piece according to ASTM D792, and the results were listed in Table 2.

### Comparative Example 11

The invention has been described in detail with reference to exemplary embodiments thereof. However, it will be appreciated by those skilled in the art that changes may be made in these embodiments without departing from the principles and spirit of the invention, the scope of which is defined in the appended claims and their equivalents.

The thermoset resin to prepare a test piece was prepared by mixing a low viscosity epoxy resin (KFR-320(Kukdo Chemical Co., Ltd.)) and a hardener (KFH-350(Kukdo Chemical Co., Ltd.)) followed by mixing an aliphatic glycidyl ether di-functional diluent 30 wt % thereto for lower viscosity. Three layers of carbon non-woven fabric having weight per unit area of 300 g/m² were put into a prepared mold, and then as shown in FIG. 1, the resin transfer molding was conducted under low pressure, e.g., 1˜10 torr. The hardening was conducted at 60° C. for 5 hours followed by further hardening at a room temperature for 24 hours. As a result, the resin content was 81 wt %, and the carbon non-woven fabric content was 19 wt %. Specific gravity, flexural properties and tensile properties of the test piece were measured and listed in Table 1.

### Comparative Example 2

Two layers of 50K twill textile (2/2 Twill fabric, Zoltek Corporation were put into a prepared mold, and then as shown in FIG. 1, the resin transfer molding was conducted with the resin, which is same with the resin prepared in Comparative Example 1, under low pressure. The hardening was conducted at 60° C. for 5 hours followed by further hardening at a room temperature for 24 hours. As a result, the resin content was 31 wt %, and the carbon non-woven fabric content was 69 wt %. Specific gravity, flexural properties and tensile properties of the test piece were measured and listed in Table 1.

### Example 1

One layer of carbon non-woven fabric having weight per unit area of 300 g/m² and one layer of 50K twill textile (2/2 Twill fabric, Zoltek Corporation) were layered as shown in FIG. 1, and then as shown in FIG. 1, the resin transfer molding was conducted with the resin, which is same with the resin prepared in Comparative Example 1, under low pressure. The hardening was conducted at 60° C. for 5 hours followed by further hardening at a room temperature for 24 hours. As a result, the resin content was 54 wt %, and the carbon non-woven fabric content was 46 wt %. Specific gravity, flexural properties and tensile properties of the test piece were measured and listed in Table 1.

TABLE 1

| | | Flexural | Flexural | Tensile | Tensile | |
|---|---|---|---|---|---|---|
| | Specific | Strength | Rigidity | Strength | Rigidity | Resin:Carbon |
| | Gravity | [MPa] | [GPa] | [MPa] | [GPa] | Ratio |
| Comp. | 1.17 ± 0.005 | 74.8 ± 8.3 | 2.3 ± 0.3 | 43.0 ± 6.3 | 1.2 ± 0.2 | 81:19 |
| Ex. 1 | | | | | | |
| Comp. | 1.48 ± 0.019 | 386.4 ± 97.8 | 22.1 ± 7.7 | 445.3 ± 32.0 | 11.8 ± 0.5 | 31:69 |
| Ex. 2 | | | | | | |
| Ex. 1 | 1.30 ± 0.015 | 832.3 ± 285 | 77.9 ± 33.5 | 142.9 ± 24.6 | 5.2 ± 0.4 | 54:46 |

As shown in Table 1, Example 1 prepared with the carbon fiber composite according to the present invention has enhanced properties such as 2 or more times flexural strength and 3 or more times flexural rigidity as compared with the test piece prepared from only a carbon non-woven fabric (Comparative Example 1) as well as the test piece prepared from only a 50K carbon fiber twill textile (Comparative Example 2). This effect may be resulted from that the test piece prepared from the inventive carbon fiber composite has a compression force-resistant structure at the upper part thereof and a tensile force-resistant structure at the lower part thereof, while compression force acts on the upper part of a test piece and tensile force acts on the lower part of the test piece when force of certain amount or more acts in a direction perpendicular to the test piece to flex thereof. Further, as shown in Table 1, the composite according to the present invention has a lower specific gravity as compared with the test piece prepared from only large tow (50K) carbon fiber textile, so that it can be applied to a ultra light structure which needs to have excellent flexural properties.

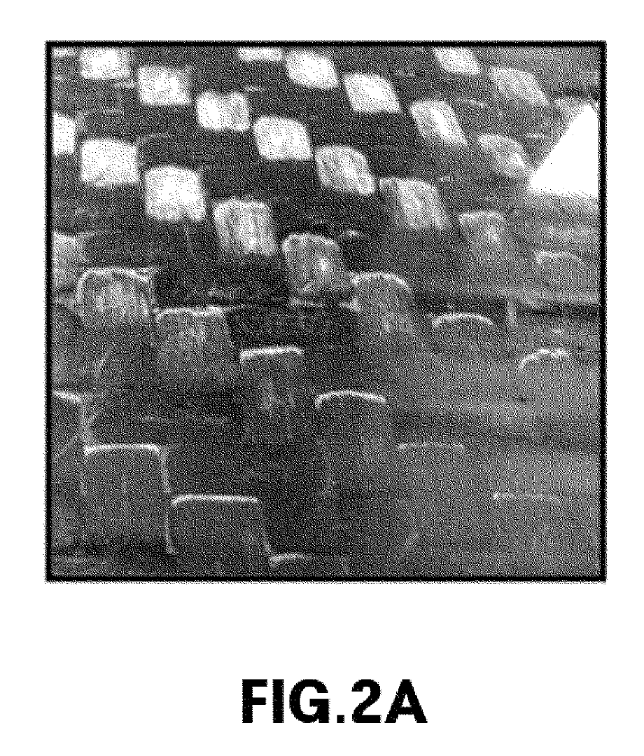

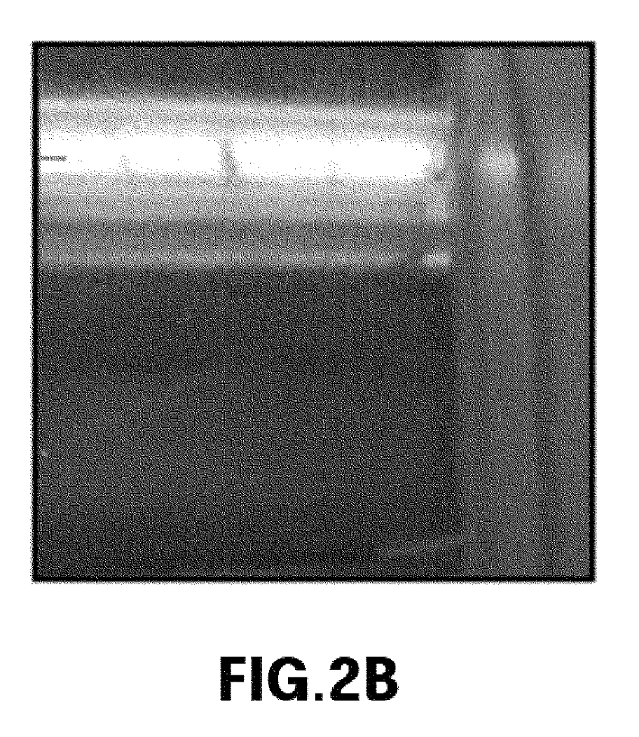

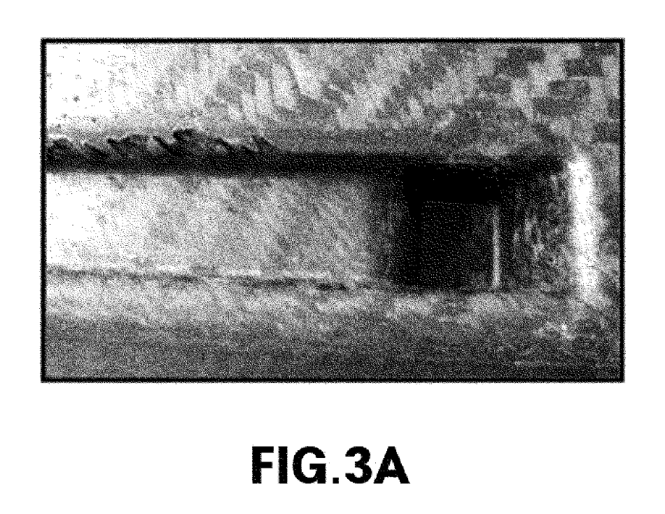

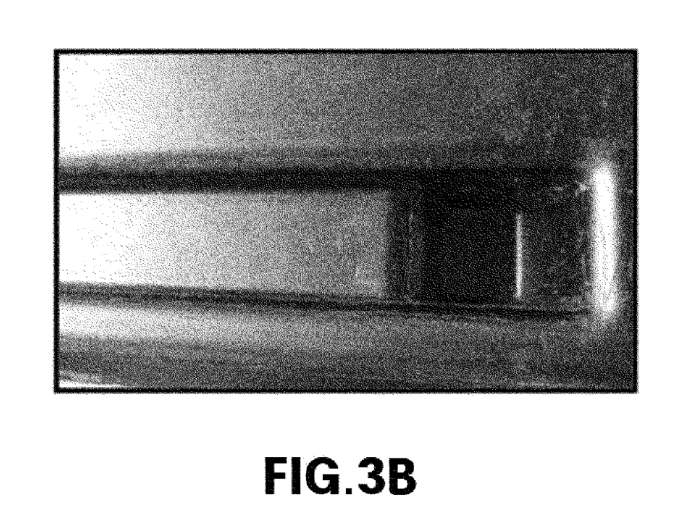

As shown in FIG. 2, when a planar test piece is prepared with the large tow carbon fiber textile, an embossing phenomenon was generated by resin non-impregnation or resin shrinkage at the carbon fiber gap. The same phenomenon was not incurred by using the carbon fiber composite according to the present invention. Furthermore, as shown in FIG. 3, when a product having flexure was molded by using the large tow carbon fiber, resin non-impregnation was incurred at the flexural part, but when the inventive composite is applied thereto, the same phenomenon was not appeared.

The carbon fiber composite according to the present invention advantageously prevents or reduces surface property deterioration which occurs when a large tow carbon fiber composite is molded to improve the productivity and to reduce costs, and at the same time, has flexural property enhancement and lightening effect through specific gravity reduction. Therefore, the carbon fiber composite according to the present invention can provide good flexural and surface properties to a vehicle structure having complicated shape or a semi-structure molded product.

What is claimed is:

1. A carbon fiber composite comprising:
30 to 80 wt % of a carbon fiber textile wherein a carbon fiber tow size is 24K to 100K;
0.1 to 20 wt % of a carbon non-woven fabric; and
10 to 70 wt % of a polymer resin.

2. The carbon fiber composite of claim 1, wherein the carbon non-woven fabric is located on a surface of the carbon fiber textile.

3. The carbon fiber composite of claim 1, wherein a weight per unit area of the carbon non-woven fabric is in a range of 10 to 500 g/m².

4. The carbon fiber composite of claim 1, wherein a viscosity of the polymer resin at transference thereof is in a range of 0.01 to 10 PA·s.

5. The carbon fiber composite 1, wherein the carbon fiber textile has a plain weave, twill weave or satin weave.

6. The carbon fiber composite of claim 1, wherein a crystal size of the carbon fiber measured by Wide-Angle X-ray Scattering method is 1 to 6 nm, and an average single fiber diameter is in a range of 1 to 20 μm.

7. The carbon fiber composite of claim 1, wherein a glass fiber or aramid fiber is further mixed to the carbon fiber.

8. The carbon fiber composite of claim 1, a glass wool or discontinuous fiber non-woven fabric is mixed and applied to the carbon non-woven fabric.

9. The carbon fiber composite of claim 3, wherein the polymer resin comprises an isophtalic polyester, vinylester-based resin and low viscosity epoxy resin.

10. The carbon fiber composite of claim 1, which further comprises a flame retardant, antioxidant, heat stabilizer, lubricant, dye, pigment and inorganic filler.

11. A vehicle part composed of:
a carbon fiber composite comprising:
30 to 80 wt % of a carbon fiber textile wherein a carbon fiber tow size is 24K to 100K;
0.1 to 20 wt % of a carbon non-woven fabric; and
10 to 70 wt % of a polymer resin.

12. The carbon fiber composite of claim 11, wherein the carbon non-woven fabric is located on a surface of the carbon fiber textile.

13. The carbon fiber composite of claim 11, wherein a weight per unit area of the carbon non-woven fabric is in a range of 10 to 500 g/m².

14. The carbon fiber composite of claim 11, wherein a viscosity of the polymer resin at transference thereof is in a range of 0.01 to 10 Pa·s.

15. The carbon fiber composite 11, wherein the carbon fiber textile has a plain weave, twill weave or satin weave.

16. The carbon fiber composite of claim 11, wherein a crystal size of the carbon fiber measured by Wide-Angle X-ray Scattering method is 1 to 6 nm, and an average single fiber diameter is in a range of 1 to 20 μm.

17. The carbon fiber composite of claim 11, wherein a glass fiber or aramid fiber is further mixed to the carbon fiber.

18. The carbon fiber composite of claim 11, wherein a glass wool or discontinuous fiber non-woven fabric is mixed and applied to the carbon non-woven fabric.

19. The carbon fiber composite of claim 13, wherein the polymer resin comprises an isophtalic polyester, vinylester-based resin and low viscosity epoxy resin.

20. The vehicle part of claim 11, wherein the carbon fiber composite further comprises a flame retardant, antioxidant, heat stabilizer, lubricant, dye, pigment and inorganic filler.
